(19) United States
(12) Patent Application Publication
(10) Pub. No.: US 2026/0236373 A1
(43) Pub. Date: Aug. 13, 2026

(54) SOFTWARE TEST LIBRARY APPLICATION OPTIMIZATIONS

(71) Applicant: Arm Limited, Cambridge (GB)

(72) Inventors: Adam Lewandowski, Middleton (GB); Xiang Jiang, Cambridge (GB)

(21) Appl. No.: 19/052,556

(22) Filed: Feb. 13, 2025

(51) Int. Cl. G06F 11/362; G06F 11/3604; G06F 11/3668

(52) U.S. Cl. CPC G06F 11/3644; G06F 11/3604; G06F 11/3684

(57) ABSTRACT

Software Testing Library (STL) runtimes are optimized by: detecting a plurality of insertion points within binary code of an application, wherein a segment interval to execute a code segment between adjacent insertion points is at most a fault tolerant time interval; segmenting the binary code into a set of code segments, each beginning with one of the insertion points; for each of the code segments, analyzing code instructions of that code segment to determine a set of functional blocks of a processor needed to process the code instructions; determining a set of segment-specific STL tests for the set of functional blocks; and injecting STL calls into the binary code at each of the insertion points, wherein each of the STL calls are restricted to a corresponding one of the set of segment-specific STL tests.

### BACKGROUND

In recent years, the number of automotive and industrial applications with functional safety requirements has grown significantly. Fault detection and consistency checking on hardware components of these systems is important. Some of these systems provide processors with a built-in self-test mechanism and a set of test routines, known as Software Test Libraries (STL). The STL is a collection of individual software tests. The collection of software tests can be repetitively executed at runtime, with each of the tests diagnosing a particular failure within the processor.

STL integration into the processor workload (e.g., the application software) has been previously done in a couple of ways. A first method regularly schedules all tests within the software test library (e.g., every test routine) during a time interval in which the fault is to be detected. While comprehensive and automatic, this method can be wasteful as test routines that are not currently applicable to the current application software are run during every time interval. A second method involves having knowledgeable test personnel manually insert the relevant test routines in the proper places of the application code binary. While the number of tests run every time interval can be reduced, the manual process can be time-consuming and subject to human error.

### BRIEF SUMMARY

Software Test Library (STL) application optimizations are described. In some aspects, a computer-implemented method optimizes Software Testing Library (STL) runtimes by: detecting a plurality of insertion points within binary code of an application, wherein a segment interval to execute a code segment between adjacent insertion points is at most a fault tolerant time interval; segmenting the binary code into a set of code segments, each beginning with one of the insertion points; for each of the code segments, analyzing code instructions of that code segment to determine a set of functional blocks of a processor needed to process the code instructions; determining a set of segment-specific STL tests for the set of functional blocks; and injecting STL calls into the binary code at each of the insertion points, wherein each of the STL calls are restricted to a corresponding one of the set of segment-specific STL tests.

In some aspects, the computer-implemented for optimizing STL runtimes by: defining a plurality of insertion points for code to segment the code into a set of code segments, each of the code segments having a segment interval that is at most a fault tolerant time interval, wherein the segment interval is a duration for a processor to execute segment instructions of a corresponding one of the code segments, wherein the processor includes a set of functional blocks, wherein different ones of the functional blocks are used to execute different types of code instructions; analyzing each of the code segments to discover a set of the functional blocks used in executing corresponding code instructions; determining for each of the code segments segment-specific STL tests to be executed given the discovered set of functional blocks, wherein different STL tests are used to test different ones of the functional blocks; and injecting at each of the insertion points, a call to perform the segment-specific STL tests determined for a corresponding one of the code segments.

In some aspects, a computer-implemented method reduces harmful micro-optimizations performed by compilers in context of applications running STL tests by: prior to performing an optimization during compilation, determining a set of functional blocks of a processor involved in the optimization, wherein one functional block of the set of functional blocks is a semi-dormant functional block; ascertaining a cycle gain, wherein the cycle gain is a number processor cycles saved by the optimization; determining a cycle cost, which is a number of processor cycles consumed by executing a set of STL tests for the semi-dormant functional block; and performing the optimization during the compilation only when the cycle gain is greater than the cycle cost.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1A is a conceptual flow diagram illustrating a code-to-function-block mapping that exists for each code segment defined based on presence of a heartbeat mechanism existing within application code.

FIG. 1B presents a diagram consistent with FIG. 1A from an event perspective, where sample binary code for an instance of a code segment is illustrated.

FIG. 1C is a conceptual flow diagram illustrating a functional block to STL test mapping occurring at insertion points and as established by FIG. 1A and FIG. 1B.

FIG. 2A provides a flow chart for a computer-implemented method for optimizing Software Testing Library (STL) runtimes.

FIG. 2B is a flow chart for a process for injecting STL tests within the fault tolerant time interval consistent with FIG. 1A-1C.

FIG. 2C shows a process for ensuring compiler optimizations occur for code with consideration being made for STL runtimes.

FIG. 3A shows a system that receives executable code as input, inserts optimized STL calls, and outputs executable code with the STL calls.

FIG. 3B shows an integrated development environment (IDE) for performing the STL test optimizations detailed in FIGS. 1A, 1B, 1C, FIG. 2A, and FIG. 2B.

### DETAILED DESCRIPTION

Software Test Library (STL) application optimizations are described. One optimization method optimizes STL runtimes by defining insertion points for code to segment the code into a set of code segments. The code within which insertion points are defined and to which STL calls are added, can include binary code also referred to as executable code or as machine code. Each insertion point is a boundary delineating different code segments (e.g., portions of binary code) from one another. Each of the code segments has a segment interval that is at most a fault tolerant time interval. The segment interval is a duration for a processor to execute segment instructions of a corresponding one of the code segments. The fault tolerant time interval is a duration or time budget during which a fault must be detected and resolved.. The processor includes a set of functional blocks, where different ones of the functional blocks are used to execute different types of code instructions. Each of the code segments are analyzed to discover a set of the functional blocks used in executing corresponding code instructions. For each of the code segments, segment-specific STL tests to be executed are determined given the discovered set of functional blocks. Different STL tests are used to evaluate different ones of the functional blocks. At each of the insertion points, a call is injected to perform the segment-specific STL tests determined for a corresponding one of the code segments.

Another optimization reduces harmful micro-optimizations performed by compilers in context of applications running STL tests. Prior to performing an optimization during compilation, a set of functional blocks of a processor involved in the optimization is determined. One functional block of the set of functional blocks is a semi-dormant functional block. A cycle gain is ascertained, wherein the cycle gain is a number processor cycles saved by the optimization. A cycle cost is determined, which is a number of processor cycles consumed by executing a set of STL tests for the semi-dormant functional block. The optimization during the compilation is only performed when the cycle gain is greater than the cycle cost. Semi-dormant can refer to a functional block being barely used for a given code segment. Both the STL related optimizations can be performed together or each can be separately performed.

Stated differently, in some embodiments, application code, such as binary code, is automatically examined and STL calls are inserted into appropriate code segments. These STL calls are optimized to only perform a subset of tests needed for a given segment interval. Some processors include a number of functional blocks, each being used to process different types of code instructions. A functional block not needed to execute instructions within a segment interval does need not be tested during that interval. Minimizing the number of STL tests, saves processing cycles.

In some embodiments, STL test costs are considered for compilers as part of application optimization. Optimizations are performed at compile time that result in a processor cycle gain greater than the processor cycle cost for running STL tests needed to test functional blocks not used but for the optimizations.

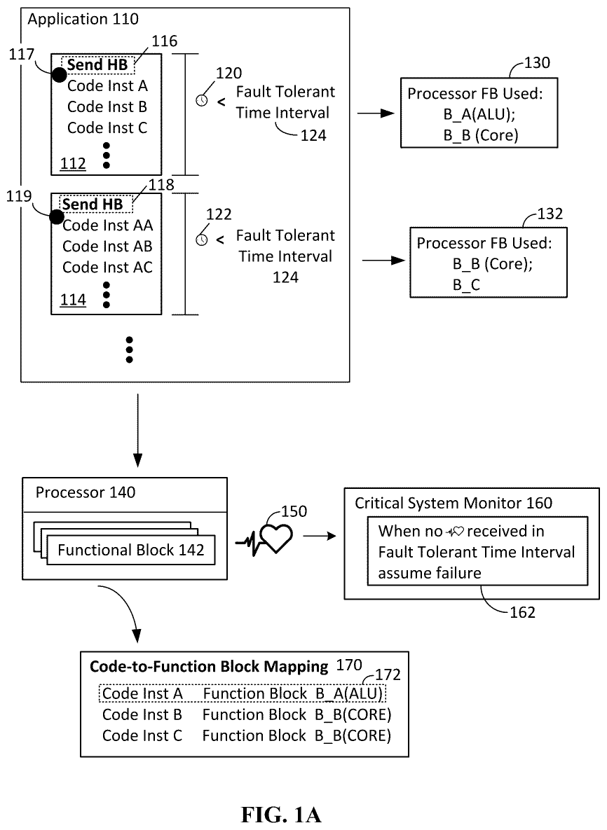

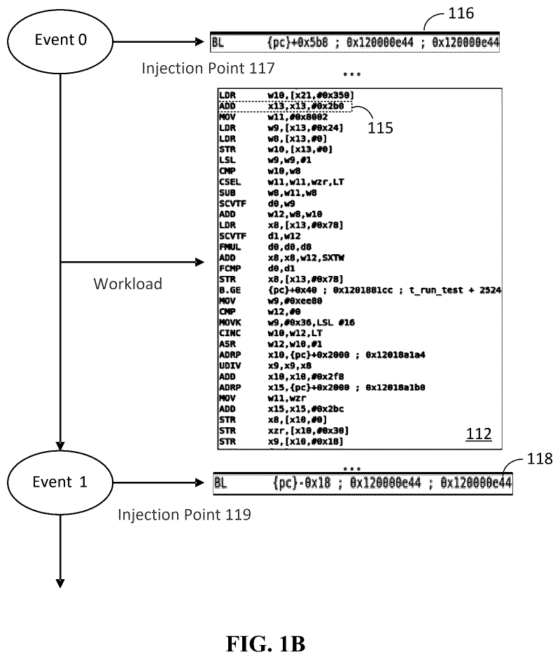

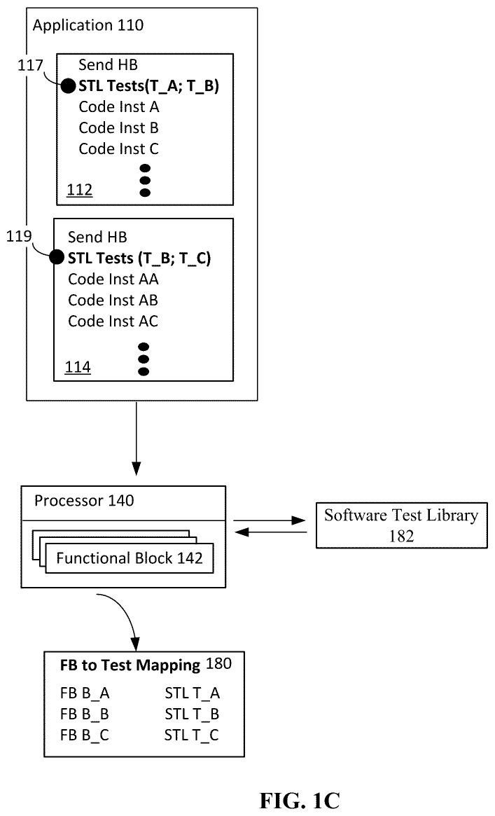

In certain embodiments, a heartbeat mechanism can exist that generates a periodic signal to indicate normal operations. When the heartbeat mechanism fails to convey this periodic signal within an anticipated time interval, the component anticipating the periodic signal assumes a failure and takes responsive action. In certain embodiments, binary code can be analyzed to determine when code is sending a heartbeat signal, which is associated with a fault tolerant time interval. Placement or detection of the insertion points within binary code can be proximate to the heartbeat code. In certain embodiments, as seen in FIG. 1A, a heartbeat signal 150, which is sent to a critical system monitor 160 is triggered by code (e.g., send HB) to send a heartbeat (116, 118). Insertion points (117, 119) placements occur immediately after code for the heartbeat (116, 118). Code segments between these insertion points are analyzed to determine which tests need to be run. First, a set of functional blocks used to handle instructions is determined, which can be based on instruction to function block mappings 170. Second, a set of STL tests for each of the functional blocks is determined, which can be based on function-block-to-test mappings 180. Once a segment-specific set of STL tests is determined (130, 132 of FIG. 1C), calls to the segment specific STL tests are made at the respective insertion points (See 117, 119 of FIG. 1C).

A STL is a suite of tests which can be executed on a processor to check the correct operation of its internal logic. STLs can be run at startup and during operation to ensure underlying hardware is executing correctly. Each appropriate STL test is scheduled to run at least once during a defined test time interval, sometimes referred to as a coverage time tick.

These coverage time ticks correspond to segment intervals (120, 122). When heartbeat mechanisms are leveraged for STL call placement, the fault tolerant time interval associated with heartbeat signals must be less than the segment interval. STLs are used in many contexts, such as complying with/supporting systematic capability for Automotive Safety Level (ASIL) D of International Organization for Standardization (ISO) 20262 (i.e., an automotive standard) as well as supporting International Electrotechnical Commission (IEC) 61508 (i.e., an industrial standard). In certain embodiments, the application 110 is a real-time application compliant with ISO 20262.

FIG. 1A is a conceptual flow diagram illustrating showing insertion points for STL tests being placed within code based on code positions for sending heartbeat signals 150. In FIG. 1A a plurality of insertion points (117, 119) (e.g., location for insertion points) are detected within code of application 110. The code is segmented into a set of code segments 112 and 114), each beginning with one of the insertion points 117 and 119. For each code segment 112, 114, a segment interval between adjacent insertion points 117 and 119 is at most a fault tolerant time interval 124. For each of the code segments 112 and 114, code instructions are analyzed to determine a set (130, 132) of functional blocks 142 of a processor 140 needed to process the code. Different ones of the functional blocks 142 are used to execute different types of code instructions. A set of segment-specific STL tests for the set of functional blocks (FBs) (see mapping 180 of FIG. 1C) are determined. Different STL tests are used to test different ones of the functional blocks 142. STL calls are injected into the code at each of the insertion points 117, 119 (see calls at insertion points 117, 119 in FIG. 1C). Each of the STL calls are restricted to a corresponding one of the set of segment-specific STL tests. That is, only those STL tests needed for active functional blocks 142 are injected. If a code segment 112, 114 does not need to utilize a specific functional block 142 corresponding STL tests are not executed within the respective segment interval 120, 122.

In some embodiments, a code-to-function-block mapping 170 can be established to determine the set of function blocks 142 used for each code segment 112 and 114. Similarly, a function-block-to-test mapping 180 can be established to determine a set of STL tests used for each code segment 112 and 114 given the determined function blocks 142 used for processing that code segment 112 and 114.

As shown, application 110 includes code that includes a set of calls 116 and 118. Application 110 can be a “real-time application” that is software that depends not only on logical correctness but also on completions within some time deadlines, which a user often perceives as occurring in a relatively immediate fashion. For the real-time application 110, faults must be detected and handled within the fault tolerant time interval. The fault tolerant time interval includes an interval for fault detection plus fault reaction. If a fault tolerant time interval is 200 ms, any fault able to occur within a system must be detected and resolved within this 200 ms time interval. Different real-time applications have different fault tolerant time intervals and the 200 ms interval is intended as a non-limiting example.

In certain embodiments, the code is executable or binary code. In other embodiments, the code includes source code and/or p-code.

The heartbeat mechanism ensures a heartbeat signal 150 is conveyed to a critical system monitor 160 in a segment interval 120, 122 less than or equal to a fault tolerant time interval 124 established by the critical system monitor 160. The critical system monitor 160 is a device or circuit that assumes that when no heartbeat signal is received within the fault tolerant time interval, a failure has occurred, as noted by element 162. Safety systems in automobiles often rely on real time monitors, such as critical system monitor 160. Although heartbeat signals 150 will generally occur immediately before the fault tolerant time interval 124, a slight variance in timing may exist so that call 116 may be associated with a segment interval 120, which is slightly different from segment interval 122 associated with call 118. Regardless, the segment interval 120, 122 is less than the fault tolerant time interval 124.

Code segments 112 and 114 include a set of code instructions to be executed by processor 140 typically in real time (e.g., with a latency resulting in operation that is sensed by a user as being immediate or current). Executions of code segments 112 and 114 by processor 140 occurring within segment interval 120 and 122, respectively. Each code segment 112, 114 includes a set of code instructions, which are executed. For example, code segment 112 includes Code Instruction A, Code Instruction B, Code Instruction C, etc. as shown. Real time implementations ensure that execution of code lines of a code segment 112, 114 by the processor 140 are not interrupted, so that execution intervals equal to or less than segment intervals 120 and 122 are guaranteed. Various embodiments of the described techniques can be implemented within any environment able to guarantee segment interval 120 and 122.

In some embodiments, processor 140 can be a central processing unit (CPU) or system-on-chip (SOC) able to call STL tests. In certain embodiments, the processor 140 could be a graphical processing unit (GPU) or numeric processing unit (NPU). Different code instruction types are executed by different functional blocks 142 of the processor 140. A code-to- functional block mapping 170 exists, such that a determination can be made as to which functional blocks 142 are needed to execute which code instructions. For example, mapping 172 can indicate that a Code Instruction A is executed by a functional block referred to as B_A 172. All code instructions for a segment 113 are analyzed per the mapping 170 so that a set of functional blocks needed per each code segment 112, 114 are determined. For code segment 112, the functional block set 130 includes two functional blocks, referred to as B_A and B_B. For code segment 114, the functional block set 132 includes two functional blocks, referred to a B_B and B_C. An insertion point 117, 119 for placing STL calls is defined for the code segments 112, 114.

FIG. 1B presents a diagram consistent with FIG. 1A from an event perspective, where sample binary code for an instance of a code segment is illustrated. As shown, Event 0 corresponds to an initiation of segment interval 120. Event 1 corresponds to an initiation of segment interval 122. Execution of code segment 112 represents a workload handled by processor 140 within segment interval 120. As shown, a code instruction “BL . . . ” is a call 116 to send heartbeat signal 150 to monitor 160. The “ADD . . . ” code instruction 115 can correspond to Code Instruction A of FIG. 1A, which is processed by functional block 142, which can be an arithmetic logic unit (ALU) of processor 140.

Although insertion points 117 and 119 are shown as occurring immediately after an instruction for call 116 and 118, placement position after a call 116, 118 is not required, so long as the segment interval 120, 122 between calls 116 and 118 is able to be leveraged for inserting new STL calls. For example, the insertion points 117, 119 can occur in a code position on a line immediately before call 116 and 118.

FIG. 1C is a conceptual flow diagram illustrating a functional block to STL test mapping 180 occurring at insertion points 117 and 119 as established by FIG. 1A and FIG. 1B. As discussed in FIG. 1A, a functional block set 130 is defined for code segment 112 and another functional block set 132 is defined for code segment 114. These functional block sets 130, 132 are different, as functional block set 130 uses two functional blocks referred to as B_A and B_B and functional block set 132 uses functional block B_B as well as a functional block referred to as B_C.

Different functional blocks are associated with different tests of the STL 182. Functional block to test mapping 180 is created that defines which STL tests should be executed for any given set of functional blocks. For conceptual simplicity, FIG. 1C shows functional block B_A is associated with a STL test referred to as T_A; functional block B_B is associated with STL test T_B, and B_C is associated with STL test T_C. In various embodiments, multiple STL tests can be conducted for a single functional block. STL 182 tests and their applicability are clearly defined for a given processor 140 type, which makes mapping 180 a straightforward and relatively trivial process. For example, the Cortex-A53 processor has a clearly defined set of STL tests mapped to functional blocks.

With reference to FIG. 1B and FIG. 1C, a call to the set of STL tests is injected at the insertion point. For insertion point 117 of code segment 112, the STL tests for T_A and T_B are called. For insertion point 119 of code segment 114, the STL tests for T_B and T_C are called.

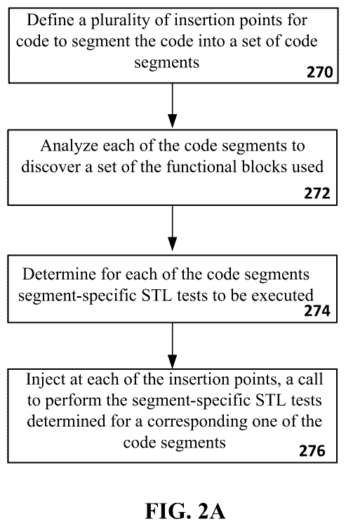

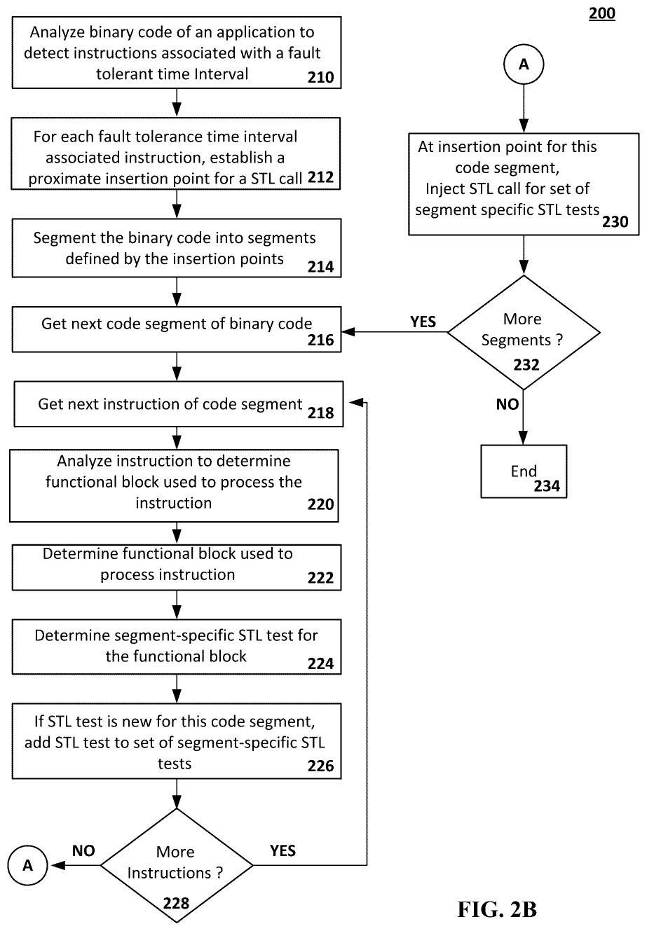

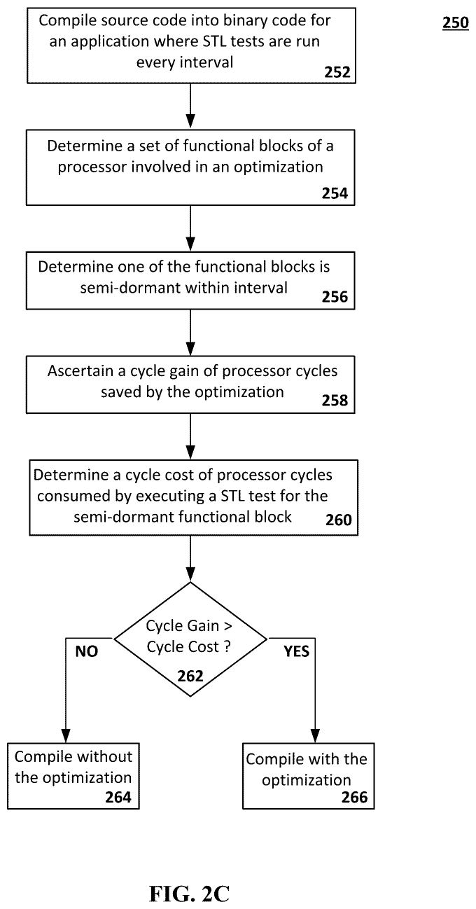

FIG. 2A provides a flow chart for a computer-implemented method for optimizing Software Testing Library (STL) runtimes. In step 270, a plurality of insertion points are defined for code to segment the code into a set of code segments (see e.g., FIG. 1A). Each of the code segments has a segment interval that is at most a fault tolerant time interval. The segment interval is a duration for a processor to execute segment instructions of a corresponding one of the code segments. The processor includes a set of functional blocks such that different ones of the functional blocks are used to execute different types of code instructions. In step 272, each of the code segments is analyzed to discover a set of the functional blocks used in executing corresponding code instructions. In step 274, For each of the code segments, segment-specific STL tests to be executed are determined given the discovered set of functional blocks. The different STL tests are used to test different ones of the functional blocks. In step 276, at each of the insertion points, a call to perform the segment-specific STL tests is injected. The STL tests are a set of STL tests determined for a corresponding code segments.

FIG. 2B is a flow chart for a process 200 for injecting STL tests within the fault tolerant time interval consistent with FIGS. 1A-1C. Process 200 begins in step 210, where binary code of an application is analyzed to detect instructions associated with the fault tolerant time interval, or heartbeat mechanism. Significantly, the process 200 can rely on binary code without needing source code. In certain embodiments, code at higher level in the stack can be handled. It is assumed that some time buffers exist so that the fault tolerant time interval plus the time needed to run the STL tests can occur without exceeding the fault tolerant time interval or the segment interval. That is, the segment interval is less than a sum of the fault tolerant time interval and an interval needed to execute the set of segment-specific STL tests.

In step 212, for each fault tolerant time interval associated instruction (e.g., a heartbeat call), an insertion point can be established (e.g., detected/identified/defined in various implementations) for a STL call. At the time the insertion point is located, the exact STL tests to be called may not be known, as these are determined for each segment through execution of steps 216-232. In step 214, the binary code is segmented to segments defined by placement of the insertion points. Each code segment can be handled and analyzed one at a time, after the segmentation of the binary code occurs.

In step 218, a next instruction for the code segment can be obtained. In step 220, the instruction can be analyzed to determine a functional block used to process the instruction. In step 222, the functional block used to process the instruction can be determined. In step 224, a segment specific STL tests (or set thereof) is determined for the functional block. In step 226, if the STL test(s) is new for this code segment, the STL tests can be added to a set of segment-specific STL tests. When there are more instructions for the segment, the process 200 loops from step 228 to step 218. Otherwise, it proceeds from step 228 to step 230.

Per steps 218-228, code instructions of a code segment are analyzed to determine a set of functional blocks of a processor needed to process the code instructions. Further, a set of segment-specific STL tests for the set of functional blocks is determined.

In step 230, at the insertion point for the code segment, an STL call can be injected for the set of segment-specific STL tests. Thus, a set of STL calls restricted to a corresponding one of the set of segment-specific tests needed to be run are injected into the binary code at an appropriate one of the insertion points.

If there are more segments to be processed, the process can repeat from step 232 to step 216. Otherwise, it ends 234.

FIG. 2C shows a process 250 for ensuring compiler optimizations occur for code with consideration being made for STL runtimes. Specifically, sometimes conventional optimizations occur, which are inefficient because such a compiler fails to consider added processing cycles needed for STL tests, which is resolved herein. Process 250 can occur in conjunction with process 200 or can occur independently.

In step 252, source code for an application is compiled into binary code, where STL tests are to be run every fault tolerant time interval. In step 254, a set of functional blocks of the CPU involved in a compiler optimization are determined. In step 256, which may be performed as part of the operation described for step 254, one of the functional blocks involved in the proposed compiler optimization can be determined to be a semi-dormant one. A semi-dormant functional block is one that is not often used. More specifically, a semi-dormant functional block is one having a reasonable likelihood of incurring a STL test cost greater than the optimization benefit that it provides.

In step 258, a cycle gain of processor cycles saved by the optimization can be ascertained. In step 260, a cycle cost of processor cycles consumed by executing a STL test for the semi-dormant functional block is determined. This determination can occur from a mapped lookup, can be estimated, or can be determined in other ways. In one embodiment, for example, it can be difficult to calculate the cycle gain verses cycle cost for a specific optimization, so the compiler can create binary code with two different paths (one for optimization and one without). The resulting binaries can be executed, and the one consuming fewer processor cycles can be ultimately selected. Regardless, numerous techniques are applicable to appropriately determine the cycle gain and cycle cost values needed by process 250 and the disclosure is not limited in this regard.

In step 262, when the cycle gain is greater than the cycle cost, compilation occurs with the optimization, as shown by step 266. When the cycle gain is not greater than the cycle cost, compilation occurs without optimization, as shown by step 264. The optimization can occur for a segment interval. In some such cases, the semi-dormant functional block determined in step 254 is a functional block that is only used to process code instructions for the single code segment of the segment interval when the optimization is performed. Here, the semi-dormant functional block is not used to process code instructions for the single code segment of the segment interval when the optimization is not performed (e.g., when step 264 occurs).

As mentioned above, process 250 can occur in conjunction with process 200 or can occur independently. When performed in conjunction with process 200, the compilation in which the optimization of step 262 occurs can generate binary code for the application on which process 200 (or similar processes) is carried out.

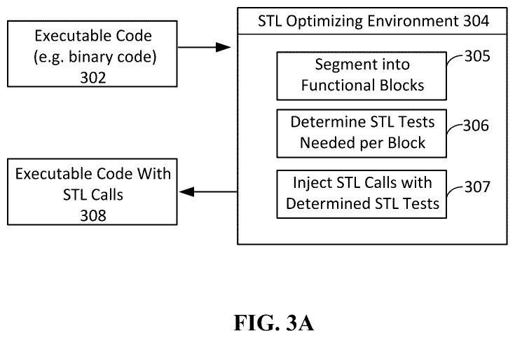

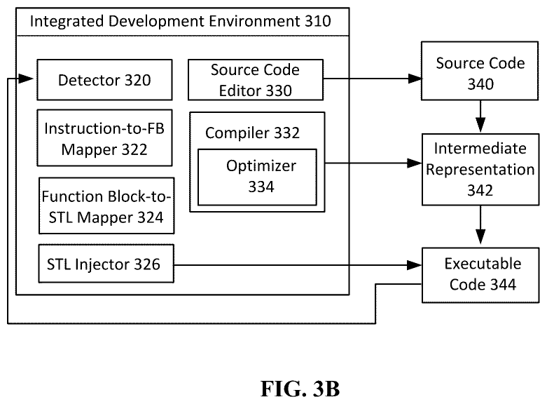

FIG. 3A shows a system that receives executable code as input, inserts optimized STL calls, and outputs executable code with the STL calls. The STL optimizing environment 304 represents a set of one or more computers and their operating environment that performs the methods and processes detailed herein, such as the method of FIG. 2A and FIG. 2B. Specifically, executable code 302 is input into environment 304. The executable code 302 is segmented into functional blocks 305. Each segment is established to ensure that any fault is detected and resolved within the fault tolerant time interval. Another software tool is utilized to determine which STL tests are needed per block 306. Finally, STL calls are injected for the determined STL tests 307. Executable code that includes STL calls 308 is output from the STL optimizing environment 304.

The various functions of segmenting, determining tests, and injecting STL calls are performed by customized software of environment 304, as opposed to being manually performed by a human. The customized software can take many forms, such as being stand-alone programs or being components of an integrated Development Environment (IDE). Although executable or binary code 302 is often used as input, other types of code including source code and intermediate code can be utilized in certain embodiments.

FIG. 3B shows an integrated development environment (IDE) 310 for performing the STL test optimizations detailed in FIGS. 1A, 1B, 1C, FIG. 2A, and FIG. 2B. The IDE 310 is a software application that consolidates a set of software development tools. For example, the IDE 310 may include a source code editor 330, enabling a developer to write and edit source code 340. In some cases, the IDE 310 can be a continuous development scenario where software builds, modifications, and conformance occurs in a secure environment that can be located in the cloud. The source code can be an application code, for example. The IDE 310 may also include a compiler 332 that translates the source code 340 from a high-level programming language to a lower-level language. In embodiments, process 250 can be performed outside of the IDE 310 based on scripts affecting a binary code file.

More specifically, the compiler 332 may receive the source code 340 and translate it to an intermediate representation 342 in a first stage of compilation. Simply put, an intermediate representation (IR) is any representation of a program between the source code and the target, or executable, code. The compiler 332 uses the intermediate representation 342 to represent the source code 340. In some cases, the intermediate representation 342 is a control flow graph showing the paths of the program using graph notation. From the intermediate representation 342, the compiler 332 generates the executable code 344 in a later stage of compilation.

The IDE 310 may also include a build tool to facilitate the generation of a ‘software build’, a debugger enabled to run the executable code 344 under controlled conditions that permit monitoring and tracking of the execution progress, and a user interface that allows a user to interact with modules of the IDE 310. Implementations of the described automatic injection of test routines of the software test library (STL) can be used in conjunction with the compiler 332 to receive the compiled test routines. Further, the compiler 332 can perform optimizations of process 250 through the use of optimizer 334.

In embodiments, the intermediate representation 342 can include P-code executed by an interpreter of a virtual machine, as is common with languages like JAVA. The intermediate representation 342 can also be a transient one used by an optimizer 334 of compiler 332. For example, consistent with process 250, a set of “test” binary representation can be used to determine whether a gain from an optimization is greater than its cost.

Insertion point detector 320 is a module of the IDE 310 able to automatically detect insertion points for adding STL calls. Insertion point detector 320 can operate against a binary file (e.g., executable code 344) as detailed by process 200. In another embodiment, the insertion points can be indicated within source code 340 or intermediate representation 342 as viewable by IDE 310. For example, linkages can be maintained so that once executable code 344 is generated, insertion points can be backwards mapped to higher levels of the step (e.g., source code 340 locations). In embodiments, the IDE 310 can permit a user to identify a heartbeat mechanism and/or a timer responsible for a heartbeat mechanism, and to establish an insertion point each time a call occurs (as detailed in FIG. 1A-1C; and FIG. 2A).

Instruction-to-functional block mapper 322 maps instructions or higher-level code portions to functional blocks of a processor. The specific processor may have to be specified within the IDE 310 to ensure proper mapping occurs for different processors having divergent structures, each of which are supported. In one embodiment, the mapping 170 of FIG. 1A would be generated and/or performed by Instruction-to-functional block mapper 322.

Functional block-to-STL mapper 324 maps functional blocks to STL tests to be performed for that functional block. In one embodiment, the mapping 180 of FIG. 1C would be generated and/or performed by functional block-to-STL mapper 324. STL injector 326 is configured to inject a set of STL tests into code portions, which are restricted to only those tests needed. Detector 320, mapper 322, 324, and injector 326 together can perform key steps of process 200 of FIG. 2A.

Compiler 332 is a program that converts instructions into machine-code or other lower-level form, which is referred to as the executable code 344. Optimizer 334 is a portion of compiler 332 that performs the steps detailed in process 250. Specifically, optimizer 334 can ensure that optimizations involving semi-dormant functional blocks do not incur costs in forms of processor cycles greater than their respective gains.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts that would be recognized by one skilled in the art are intended to be within the scope of the claims.

What is claimed is:

1. A computer-implemented method for optimizing Software Testing Library (STL) runtimes, said computer-implemented method comprising:
detecting a plurality of insertion points within binary code of an application, wherein a segment interval to execute a code segment between adjacent insertion points is at most a fault tolerant time interval;
segmenting the binary code into a set of code segments, each beginning with one of the insertion points;
for each of the code segments,
analyzing code instructions of that code segment to determine a set of functional blocks of a processor needed to process the code instructions; and
determining a set of segment-specific STL tests for the set of functional blocks; and
injecting STL calls into the binary code at each of the insertion points, wherein each of the STL calls are restricted to a corresponding one of the set of segment-specific STL tests.

2. The computer-implemented method of claim 1, wherein the fault tolerant time interval is a duration within which all faults are to be detected and resolved.

3. The computer-implemented method of claim 1, wherein the segment interval is less than a sum of the fault detection interval, an interval needed to execute the set of segment-specific STL tests, and a fault reaction time interval.

4. The computer-implemented method of claim 1, wherein the binary code comprises a plurality of code instructions representing repeating calls to a real-time safety monitor, said repeating calls occurring in a time less than the fault tolerant time interval, said computer-implemented method comprising:
detecting the plurality of repeating calls within the binary code; and
establishing one of the insertion points in the binary code for each of the repeating calls.

5. The computer-implemented method of claim 3, wherein each of the STL calls is performed at one of the insertion points.

6. The computer-implemented method of claim 1, wherein the analyzing further comprises:
analyzing a code instruction of the code segment to determine a functional block needed to execute the code instruction;
when the functional block is not included in the set of functional blocks, adding the functional block to the set of functional blocks; and
repeating the analyzing of one of the code instructions and the adding for each code instruction in the code segment.

7. The computer-implemented method of claim 1, wherein the determining further comprises:
mapping one of the functional blocks of the set of functional blocks to at least one STL test;
when the at least one STL test is not included in the set of segment-specific STL tests, adding the at least one STL tests to the set of segment-specific STL tests; and
repeating the mapping and the adding for each functional block in the set of functional blocks.

8. The computer-implemented method of claim 1, wherein after the STL calls have been injected, execution of the binary code complies with an Automotive Safety Level (ASIL) D standard of an International Organization for Standardization (ISO) established standard.

9. The computer-implemented method of claim 1, wherein the application is a real-time application compliant with ISO 20262.

10. The computer-implemented method of claim 1, wherein the detecting, segmenting, analyzing, determining, and injecting are performed automatically by software of an STL optimizing environment.

11. The computer-implemented method of claim 1, further comprising:
prior to performing an optimization during compilation of the binary code, determining a set of functional blocks of the processor involved in the optimization, wherein one functional block of the set of functional blocks is a semi-dormant functional blocks;
ascertaining a cycle gain, wherein the cycle gain is a number processor cycles saved by the optimization;
determining a cycle cost, which is a number of processor cycles consumed by executing a set of STL tests for the semi-dormant functional blocks; and
performing the optimization during the compilation only when the cycle gain is greater than the cycle cost.

12. The computer-implemented method of claim 1, wherein the detecting, segmenting, analyzing, determining, and injecting are performed automatically by an integrated development environment.

13. A computer-implemented method for optimizing Software Testing Library (STL) runtimes, said computer-implemented method comprising:
defining a plurality of insertion points for code to segment the code into a set of code segments, each of the code segments having a segment interval that is at most a fault tolerant time interval, wherein the segment interval is a duration for a processor to execute segment instructions of a corresponding one of the code segments, wherein the processor comprises a set of functional blocks, wherein different ones of the functional blocks are used to execute different types of code instructions;
analyzing each of the code segments to discover a set of the functional blocks used in executing corresponding code instructions;
determining for each of the code segments segment-specific STL tests to be executed given the discovered set of functional blocks, wherein different STL tests are used to test different ones of the functional blocks; and
injecting at each of the insertion points, a call to perform the segment-specific STL tests determined for a corresponding one of the code segments.

14. The computer-implemented method of claim 13, wherein a time needed to execute each of the segment-specific STL tests plus the segment interval is less than the fault tolerant time interval.

15. The computer-implemented method of claim 13, wherein the code is binary code.

16. The computer-implemented method of claim 13, wherein the code is at least one of source code and p-code.

17. A computer-implemented method of reducing harmful micro-optimizations performed by compilers in context of applications running Software Testing Library (STL) tests, the method comprising:
prior to performing an optimization during compilation, determining a set of functional blocks of a processor involved in the optimization, wherein one functional block of the set of functional blocks is a semi-dormant functional block;
ascertaining a cycle gain, wherein the cycle gain is a number processor cycles saved by the optimization;
determining a cycle cost, which is a number of processor cycles consumed by executing a set of STL tests for the semi-dormant functional block; and
performing the optimization during the compilation only when the cycle gain is greater than the cycle cost.

18. The computer-implemented method of claim 17, wherein the optimization occurs for a segment interval.

19. The computer-implemented method of claim 18, wherein the semi-dormant functional block is a functional block that is only used to process code instructions for a single code segment of the segment interval when the optimization is performed, wherein the semi-dormant functional block is not used to process code instructions for the single code segment of the segment interval when the optimization is not performed.

20. The computer-implemented method of claim 17, wherein the compilation generates binary code for the application, said method further comprising:
detecting a plurality of insertion points within the binary code, wherein a segment interval to execute a code segment between adjacent insertion points is at most a fault tolerant time interval; segmenting the binary code into a set of code segments, each beginning with one of the insertion points;
for each of the code segments,
analyzing code instructions of that code segment to determine a set of functional blocks of a processor needed to process the code instructions; and
determining a set of segment-specific STL tests for the set of functional blocks; and
injecting STL calls into the binary code at each of the insertion points, wherein each of the STL calls are restricted to a corresponding one of the set of segment-specific STL tests.
